(19) United States
(12) Patent Application Publication
(10) Pub. No.: US 2017/0102798 A1
(43) Pub. Date: Apr. 13, 2017

(54) TOUCH SENSE INTERVALS IN MULTIPLE DRIVE STATES

(71) Applicant: Microsoft Technology Licensing, LLC, Redmond, WA (US)

(72) Inventor: Tianzhu Qiao, Portland, OR (US)

(21) Appl. No.: 14/878,701

(22) Filed: Oct. 8, 2015

(51) Int. Cl. G06F 3/044

(52) U.S. Cl. CPC G06F 3/044

(57) ABSTRACT

A touch sensor is provided having a matrix of row electrodes and column electrodes. Associated circuitry progressively drives the row electrodes in successive touch-sensing frames, and the resulting signals on the column electrodes are processed to detect touch events. In each interval of each touch-sensing frame, a different grouping of the row electrodes is driven. Within each interval, the associated grouping is driven in multiple differently-driven drive states. For a set of possible touch events associated with the row electrodes of the grouping, the drive states produce differing drive state outputs that collectively, but not individually, are usable to detect each of the different touch events.

### BACKGROUND

Many touch sensors employ capacitance-based sensing, in which signals on a matrix of row electrodes and column electrodes are interpreted by receive circuitry to detect touch events occurring at different locations on the matrix. Drive circuitry connected to the row electrodes progressively scans the row electrodes in a touch-sensing frame, typically by applying drive signals to one row electrode at a time until all rows have been scanned in the frame. If a touch is present on a driven row, the capacitance effect of that touch interacts with the row drive signal to cause a recognizable signal to occur on the column electrode nearest the touch, thereby enabling receive circuitry to determine the row/column coordinate of the touch event. Typically, it is desirable to scan the entire touch frame as quickly as possible, in order to minimize delay and other time-related deficits.

### BRIEF DESCRIPTION OF THE DRAWINGS

FIG. 1 depicts an example touch-sensitive display device.

FIG. 2 depicts an optical stack and associated subsystems of the touch-sensitive display device of FIG. 1.

FIG. 3 depicts an example touch sensor matrix of the touch-sensitive display device of FIG. 1, including a plurality of row electrodes and column electrodes.

FIG. 4 depicts an example active stylus that may be used with the touch-sensitive display device of FIG. 1.

FIG. 5 depicts an example touch-sensing frame including a plurality of intervals. In each interval a different grouping of row electrodes is driven (row electrodes within each group are simultaneously driven). Example row electrode grouping schemes are depicted.

FIG. 6 depicts, for an example interval, an example grouping of row electrodes being driven in a plurality of differently-driven drive states, thereby yielding differing drive state outputs.

FIGS. 7A and 7B depict, for an example grouping of two row electrodes, those electrodes being activated simultaneously in two differently-drive drive states over a driving interval, so as to yield two different drive state outputs collectively usable to detect four touch events associated with the two row electrodes.

FIG. 8 depicts an example method for detecting touch events.

FIG. 9 depicts an example computing system.

### DETAILED DESCRIPTION

In touch sensor design, a common design goal is to quickly identify touch events (e.g., finger touches). In typical capacitive sensors, row electrodes of a row/column matrix are progressively driven one row at a time across the span of the matrix. This influences electrical conditions in the column circuitry. Localized touch events (i.e., near the activated electrode) alter the column signals in a way that can enable detection of the touch event. The time performance of such a system is affected by the length of time needed to scan all of the row electrodes. Thus, performance can decrease when rows need to be scanned for longer durations, and when the sensor has a greater number of rows.

The present discussion contemplates a system in which groupings of row electrodes are driven simultaneously, i.e., each grouping contains two or more electrodes that are driven simultaneously. The touch sensor matrix is divided into multiple such row electrode groupings, each of which is driven during an interval of the touch-sensing frame. Thus, over the course of the touch-sensing frame, each row electrode grouping is driven during an associated interval.

In each interval, the grouping of row electrodes is driven in multiple differently-driven drive states, each of which produces a drive state output. The drive states are differently-driven in the sense that the drive signals from state to state differ in some fashion. For example a particular row electrode might be driven with drive signals that differ from state to state. Typically, each drive state is specialized in the sense that its drive signals are focused on detecting a different specific subset of the possible touch events that can happen on the row electrodes of the grouping. In this approach, the outputs of the drive states are usable collectively, but not individually to detect all of the possible touch events.

In a specific example, each grouping has two row electrodes. Accordingly, if the touch sensor matrix has J row electrodes, there would be J/2 row electrode groupings, driven in J/2 intervals. Given there are two row electrodes, there are four possible touch events: (1) a touch at neither row; (2) a touch at the first row; (3) a touch at the second row; (4) touches at both rows. Assuming two drive states, one drive state could be specifically configured to detect three or fewer of these events, with the other state directed at the others. More specifically, identical drive signals could be applied to both row electrodes in a first drive state. Such a drive state would be directed toward detecting whether touches occurred on both row electrodes (e.g., via rapid recognition of a high-level correlation output). A second drive state could employ drive signals to the two electrodes that are phase-aligned and inverted. Such a drive state, via assessment of correlation value polarities, could determine whether a touch occurred on the first row electrode or the second row electrode.

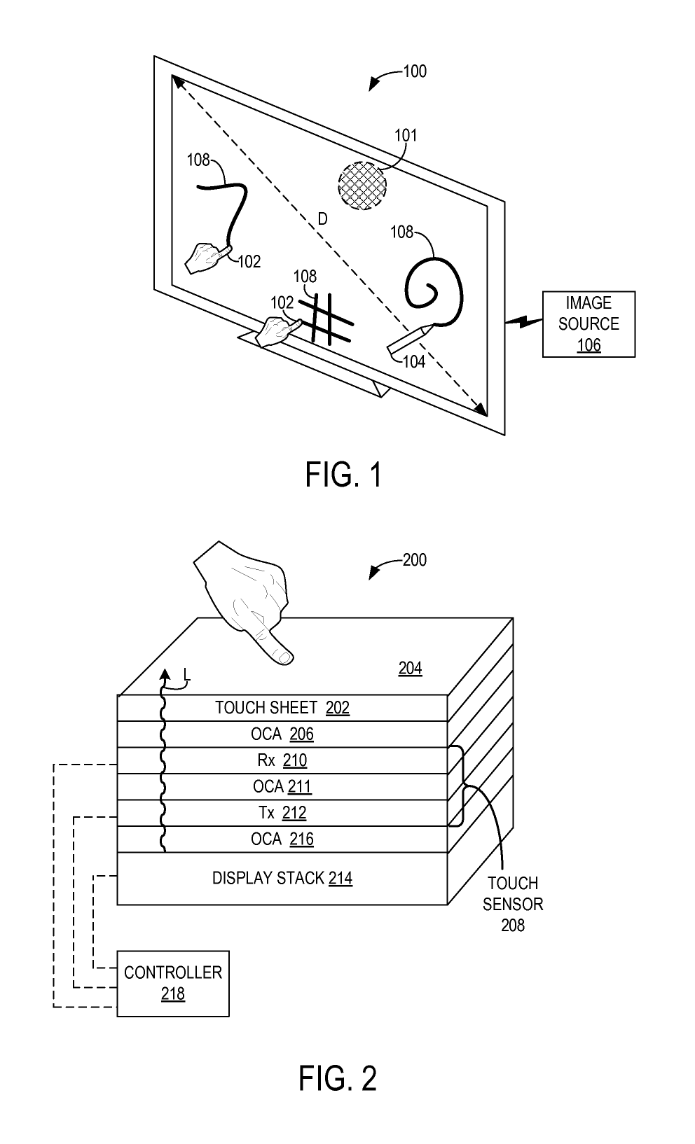

FIG. 1 shows a touch sensitive display device 100 including a touch sensor 101. In some examples, display device 100 may be a large-format display device with a diagonal dimension D greater than 1 meter, for example, though the display may assume any suitable size. Display device 100 may be configured to sense one or more sources of input, such as touch input imparted via a digit 102 of a user and/or input supplied by an input device 104, shown in FIG. 1 as a stylus. Digit 102 and input device 104 are provided as non-limiting examples and any other suitable source of input may be used in connection with display device 100. Further, display device 100 may be configured to receive input from input devices in contact with the display device 100 and input devices not in contact with the display device 100 (e.g., input devices that hover proximate to a surface of the display). “Touch input” as used herein refers to both types of input. In some examples, display device 100 may be configured to receive input from two or more sources simultaneously, in which case the display device may be referred to as a multi-touch display device.

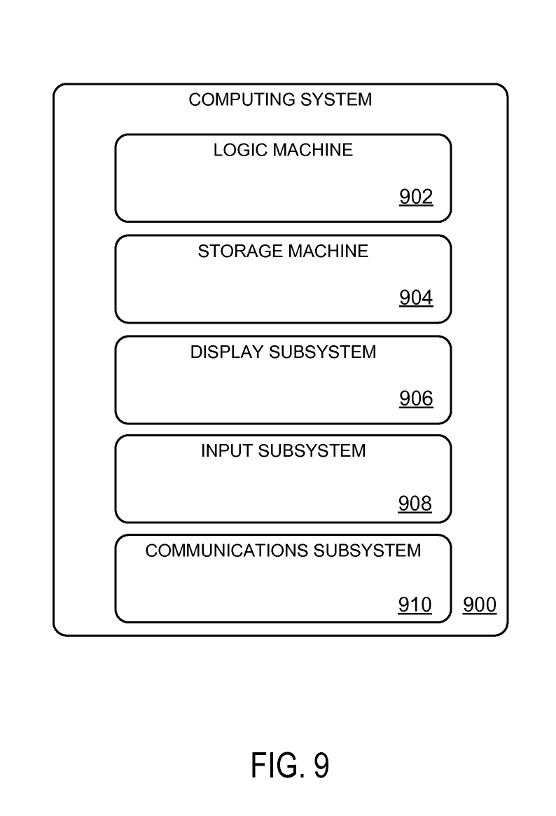

Display device 100 may be operatively coupled to an image source 106, which may be, for example, a computing device external to, or housed within, the display device 100. Image source 106 may receive input from display device 100, process the input, and in response generate appropriate graphical output 108 for the display device 100. In this way, display device 100 may provide a natural paradigm for interacting with a computing device that can respond appropriately to touch input. Details regarding an example computing device are described below with reference to FIG. 9.

FIG. 2 is a cross-sectional view of an optical stack 200 of display device 100 of FIG. 1. Optical stack 200 includes a plurality of components configured to enable the reception of touch input and the generation of graphical output. Optical stack 200 may include an optically-clear touch sheet 202 having a top surface 204 for receiving touch input, and an optically-clear adhesive (OCA) 206 bonding a bottom surface of the touch sheet 202 to a top surface of a touch sensor 208, which may correspond to touch sensor 101 of FIG. 1, for example. Touch sheet 202 may be comprised of any suitable material(s), such as glass, plastic, or another material. As used herein, “optically-clear adhesive” refers to a class of adhesives that transmit substantially all (e.g., about 99%) of incident visible light.

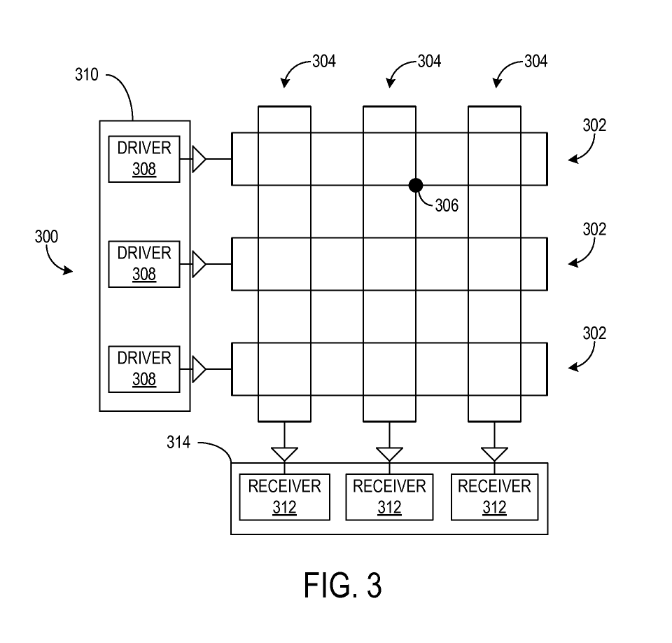

As described in further detail below with reference to FIG. 3, touch sensor 208 includes a matrix of electrodes that form capacitors whose capacitances may be evaluated in detecting touch input. As shown in FIG. 2, the electrodes may be formed in two separate layers: a receive electrode layer (Rx) 210 and a transmit electrode layer (Tx) 212 positioned below the receive electrode layer. For example, receive and transmit electrode layers 210 and 212 each may be formed on a respective dielectric substrate comprising materials including but not limited to glass, polyethylene terephthalate (PET), or cyclic olefin polymer (COP) film. Receive and transmit electrode layers 210 and 212 may be bonded together by a second optically-clear adhesive (OCA) 211. OCA 211 may be an acrylic pressure-sensitive adhesive film, for example.

The touch sensor configuration illustrated in FIG. 2 is provided as an example, and other arrangements are within the scope of this disclosure. For example, in other implementations, layers 210, 211, and 212 may be integrally formed as a single layer with electrodes disposed on opposite surfaces of the integral layer. Further, touch sensor 208 may alternatively be configured such that transmit electrode layer 212 is provided above, and bonded, via OCA 211, to receive electrode layer 210 positioned therebelow.

Receive and transmit electrode layers 210 and 212 may be formed by a variety of suitable processes. Such processes may include deposition of metallic wires onto the surface of an adhesive, dielectric substrate; patterned deposition of a material that selectively catalyzes the subsequent deposition of a metal film (e.g., via plating); photoetching; patterned deposition of a conductive ink (e.g., via inkjet, offset, relief, or intaglio printing); filling grooves in a dielectric substrate with conductive ink; selective optical exposure (e.g., through a mask or via laser writing) of an electrically conductive photoresist followed by chemical development to remove unexposed photoresist; and selective optical exposure of a silver halide emulsion followed by chemical development of the latent image to metallic silver, in turn followed by chemical fixing. In one example, metalized sensor films may be disposed on a user-facing side of a substrate, with the metal facing away from the user or alternatively facing toward the user with a protective sheet (e.g., comprised of PET) between the user and metal. Although transparent conducting oxide (TCO) is typically not used in the electrodes, partial use of TCO to form a portion of the electrodes with other portions being formed of metal is possible. In one example, the electrodes may be thin metal of substantially constant cross section, and may be sized such that they may not be optically resolved and may thus be unobtrusive as seen from a perspective of a user. Suitable materials from which electrodes may be formed include various suitable metals (e.g., aluminum, copper, nickel, silver, gold), metallic alloys, conductive allotropes of carbon (e.g., graphite, fullerenes, amorphous carbon), conductive polymers, and conductive inks (e.g., made conductive via the addition of metal or carbon particles).

Continuing with FIG. 2, touch sensor 208 is bonded, at a bottom surface of transmit electrode layer 212, to a display stack 214 via a third optically-clear adhesive (OCA) 216. Display stack 214 may be a liquid crystal display (LCD) stack, organic light-emitting diode (OLED) stack, or plasma display panel (PDP), for example. Display stack 214 is configured to emit light L through a top surface of the display stack, such that emitted light travels in a light emitting direction through layers 216, 212, 211, 210, 206, touch sheet 202, and out through top surface 204. In this way, emitted light may appear to a user as an image displayed on top surface 204 of touch sheet 202.

Further variations to optical stack 200 are possible. For example, implementations are possible in which layers 211 and/or 216 are omitted. In this example, touch sensor 208 may be air-gapped and optically uncoupled to display stack 214. Further, layers 210 and 212 may be laminated on top surface 204. Still further, layer 210 may be disposed on top surface 204 while layer 212 may be disposed opposite and below top surface 204.

FIG. 2 also shows a controller 218 operatively coupled to receive electrode layer 210, transmit electrode layer 212, and display stack 214. Controller 218 is configured to drive transmit electrodes in transmit electrode layer 212, receive signals resulting from driven transmit electrodes via receive electrodes in receive electrode layer 210, and locate, if detected, touch input imparted to optical stack 200. Controller 218 may further drive display stack 214 to enable graphical output responsive to touch input. Two or more controllers may alternatively be provided, and in some examples, respective controllers may be implemented for each of receive electrode layer 210, transmit electrode layer 212, and display stack 214. In some implementations, controller 218 may be implemented in image source 106 of FIG. 1.

FIG. 3 shows an example touch sensor matrix 300. Matrix 300 may be included in touch sensor 208 of optical stack 200 of FIG. 2 to bestow touch sensing functionality to display device 100 of FIG. 1, for example. Matrix 300 includes a plurality of electrodes in the form of transmit rows 302 vertically separated from receive columns 304. Transmit rows 302 and receive columns 304 may be respectively formed in transmit electrode layer 212 and receive electrode layer 210 of optical stack 200, for example. Each vertical intersection of transmit rows 302 with receive columns 304 forms a corresponding node such as node 306 whose electrical properties (e.g., capacitance) may be measured to detect touch input. Three transmit rows 302 and three receive columns 304 are shown in FIG. 3 for the purpose of clarity, though matrix 300 may include any suitable number of transmit rows and receive columns, which may be on the order of one hundred or one thousand, for example.

While a rectangular grid arrangement is shown in FIG. 3, matrix 300 may assume other geometric arrangements—for example, the matrix may be arranged in a diamond pattern. Alternatively or additionally, individual electrodes in matrix 300 may assume nonlinear geometries—e.g., electrodes may exhibit curved or zigzag geometries, which may minimize the perceptibility of display artifacts (e.g., aliasing, moiré patterns) caused by occlusion of an underlying display by the electrodes. The transmit rows 302 and receive columns 304 may be positioned/oriented according to any suitable layout. For example, transmit rows 302 may be oriented horizontally with respect to ground, vertically with respect to ground, or at another angle. Likewise, receive columns 304 may be oriented horizontally with respect to ground, vertically with respect to ground, or at another angle.

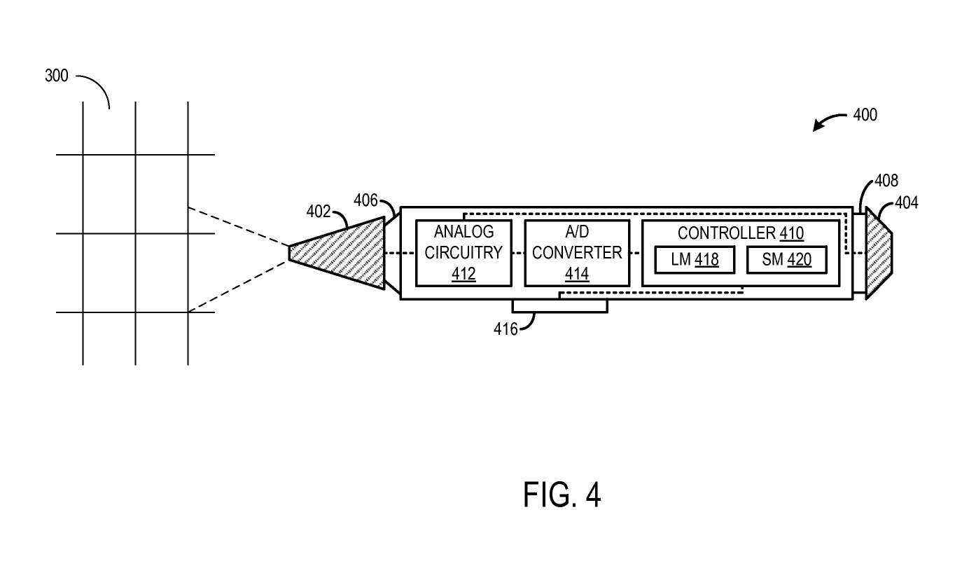

Each transmit row 302 in matrix 300 may be attached to a respective driver 308 configured to drive its corresponding transmit row with a time-varying voltage. In some implementations, drivers 308 of matrix 300 may be driven by a microcoded state machine implemented within a field-programmable gate array (FPGA) forming part of controller 218 of FIG. 2, for example. Each driver 308 may be implemented as a shift register having one flip-flop and output for its corresponding transmit row, and may be operable to force all output values to zero, independently of register state. The inputs to each shift register may be a clock, data input, and a blanking input, which may be driven by outputs from the microcoded state machine. Signals may be transmitted by filling the shift register with ones on every output to be excited, and zeroes elsewhere, and then toggling the blanking input with a desired modulation. Such signals are referred to herein as “excitation sequences”, as these signals may be time-varying voltages that, when digitally sampled, comprise a sequence of pulses—e.g., one or more samples of a relatively higher digital value followed by one or more samples of a relatively lower digital value, or vice versa. If the shift register is used in this fashion, excitation sequences may take on only two digital values—e.g., only binary excitation sequences can be transmitted. In other implementations, drivers 308 may be configured to transmit non-binary excitation sequences that can assume three or more digital values. Non-binary excitation sequences may enable a reduction in the harmonic content of driver output and decrease the emissions radiated by matrix 300. The drivers 308 may collectively be implemented as drive circuitry 310. Circuitry 310 may be configured to receive commands/inputs from one or more computer components, for example. Further, circuitry 310 may coordinate the activation of each driver 308. For example, circuitry 310 may establish an order in which each driver 308 is driven, as well as determine the signal each driver uses to drive its corresponding row. In some implementations, matrix 300 may be configured to communicate with an active stylus, such as active stylus 400 shown in FIG. 4. This implementation may at least partially enable touch sensitive display device 100 to communicate with input device 104 when matrix 300 is implemented in display device 100. Specifically, an electrostatic channel may be established between one or more transmit rows 302 and a conductive element (e.g., electrode tip) of active stylus 400, along which data may be transmitted. In one example, communication via the electrostatic channel is initiated by the transmission of a synchronization pattern from matrix 300 to active stylus 400. The synchronization pattern may enable matrix 300 and active stylus 400 to obtain a shared sense of time, and may be transmitted via multiple transmit rows 302 so that active stylus 400 can receive the pattern regardless of its position relative to the matrix. The shared sense of time may facilitate the correlation of a time at which active stylus 400 detects an excitation sequence or other signal transmitted on transmit rows 302 to a location in matrix 300, as the synchronization pattern may yield an indication of the order in which transmit rows 302 are driven. Such correlation may enable active stylus 400 to determine at least one coordinate (e.g., y-coordinate) relative to matrix 300, which may be transmitted back to the matrix (e.g., via the electrostatic channel) or to an associated display device via a different communication protocol (e.g., radio, Bluetooth). To determine a second coordinate (e.g., x-coordinate) of active stylus 400, all transmit rows 302 may be held at a constant voltage, and active stylus 400 may transmit a time-varying voltage to matrix 300, which may sequentially measure currents resulting from a voltage of active stylus 400 in each receive column 304 to ascertain the second coordinate.

Each receive column 304 in matrix 300 may be coupled to a respective receiver 312 configured to receive signals resulting from the transmission of excitation sequences on transmit rows 302. The receivers 312 may be collectively implemented as receive circuitry 314. Circuitry 314 may be configured to process and interpret electrical signals detected by the receivers, with the aim of identifying and localizing touch events performed on matrix 300. During touch detection, matrix 300 may hold all transmit rows 302 at a constant voltage except for one or more active transmit rows along which one or more excitation sequences are transmitted. During transmission of the excitation sequences, all receive columns 304 may be held at a constant voltage (e.g., ground). With the excitation sequences applied to the active transmit rows 302 and all receive columns 304 held at the constant voltage, a current may flow through each of the nodes formed by the vertical intersections of the active transmit rows with the receive columns. Each current may be proportional to the capacitance of its corresponding node. Hence, the capacitance of each node may be measured by measuring each current flowing from the active transmit rows 302. In this way, touch input may be detected by measuring node capacitance. Matrix 300 may be repeatedly scanned at a frame rate (e.g., 60 Hz, 120 Hz) to persistently detect touch input, where a complete scan of a frame comprises applying an excitation sequence to each transmit row 302, and for each driven transmit row, collecting output from all of the receive columns 304. However, in other examples, a complete scan of a frame may be a scan of a desired subset, and not all, of one or both of transmit rows 302 and receive columns 304.

Other measurements may be performed on matrix 300 to detect touch, alternatively or additionally to the measurement of capacitance—for example, a time delay between the transmission of an excitation sequence and reception of a received signal resulting from the transmitted excitation sequence, and/or a phase shift between the transmitted excitation sequence and the resulting received signal may be measured.

The above described touch sensor matrix is provided as an example, and is meant to be non-limiting. Other touch sensor configurations may be employed without departing from the scope of the present disclosure.

FIG. 4 shows an example active stylus 400. Active stylus 400 includes an electrode tip 402 on one end and an electrode eraser 404 on an opposing end. The electrode tip 402 and the electrode eraser 404 may be electrically conductive and configured to receive current when proximate to a driven electrode of electrode matrix 300 of FIG. 3. Tip 402 may include a pressure sensor 406 configured to detect a pressure when tip 402 is pressed against a surface. Likewise, eraser 404 may include a pressure sensor 408 configured to detect a pressure when eraser 404 is pressed against a surface. In one example, each of pressure sensors 406 and 408 are force sensitive resistors. A touch pressure value of each of the respective pressure sensors 406 and 408 may be sent to a controller 410. In one example, the touch pressure value may be represented by a 6 bit value.

As shown, electrode tip 402 and electrode eraser 404 are operatively coupled to analog circuitry 412. Analog circuitry 412 may include linear analog componentry configured to maintain the tip/eraser at a constant voltage and convert any current into or out of the tip/eraser into a proportional current-sense voltage.

An analog-to-digital (A/D) converter 414 is operatively coupled to analog circuitry 412 and configured to digitize voltages received from analog circuitry 412 into digital data to facilitate subsequent processing. As a non-limiting example, converter 414 may convert incoming electrostatic signals having bandwidths of 100 kHz at a sampling rate of 1 Mbit/s.

Active stylus 400 includes a barrel switch button 416 that may be depressable by a user to provide additional user input. A state of button 416 may be sent to controller 410.

The controller 410 includes a logic machine 418 and a storage machine 420 configured to hold instructions executable by logic machine 418 to perform various operations discussed herein. For example, controller 410 may be configured to receive signals from various sensors including pressure sensor 406, pressure sensor 408, and button 416. Further, controller 410 may be configured to process digitized signals from A/D converter 414 to perform other operations discussed herein.

Active stylus 400 may operate in a receive mode and a drive mode. Receive mode may be employed (1) to synchronize active stylus 400 to the computing device/processor associated with the touch-sensor, to establish/maintain a shared sense of time; and (2) to establish the Y coordinate of active stylus 400 with respect to the touch-sensor matrix (or the X coordinate in the event of vertically-oriented rows). Synchronization typically occurs at the beginning of the time frame, in which one or more rows on the touch-sensor matrix are driven with a synchronization pulse that induce/vary electrical conditions on electrode tip 402 (or electrode eraser 404) of active stylus 400. The received signal is processed, typically via a correlation operation, in order to establish/maintain the shared sense of timing. Usually, multiple rows, spanning the entire height/width of the touch-sensor matrix, are driven with the synchronization pulse so that active stylus 400 receives an adequate signal regardless of its position relative to touch-sensor matrix 300.

Active stylus 400 may also operate in a receive mode during normal scanning of the rows of touch-sensor matrix 300. In other words, active stylus 400 may receive signals while the rows are scanned to establish the X and Y coordinates of finger hover/touch on touch-sensor matrix 300. The receive circuitry typically runs a correlation operation that is tuned to the drive signal(s) being used on touch-sensor matrix 300. Upon receiving a signal of greatest amplitude (e.g., highest correlation), active stylus 400 makes a note of the timing of that highest signal. The recorded timing allows active stylus 400 and display device 100 of touch-sensor matrix 300 to know which row active stylus 400 was closest to, thereby establishing the Y position of active stylus 400. In some examples, active stylus 400 reports row position information (e.g., timing, value of a row counter) to touch-sensor matrix 300 over some type of wireless link (e.g., a radio transmitter). Instead of or in addition to a radio link, row position information may be transmitted electrostatically via excitation of the electrode tip 402 (or electrode eraser 404) of active stylus 400.

In some implementations, interpolation may be employed to increase positional resolution. For example, assuming a highest amplitude at row K, amplitudes may also be noted for rows K−2, K−1, K+1, K+2. Assessing the amplitudes for these neighboring rows can enable finer determinations of Y position. Essentially, active stylus 400 “listens” for a communication from rows, and based on the “loudness” of that communication, an assessment is made as to how close active stylus 400 is to the row that is “talking.” By assessing communication volume from a few rows on either side of the “loudest” row, a higher position granularity may be determined.

In addition to receiving during a “sync subframe” and during a “row-drive” subframe, active stylus 400 may drive its electrode (tip or eraser) during a “stylus-drive” subframe. In this case, application of a drive signal to the stylus tip electrode influences/varies electrical conditions on one or more column electrodes of the touch-sensor matrices. The column receive circuitry correlates, as described above, in order to interpret the received signals. The column experiencing the highest signal, or an above-threshold signal, is deduced to be the column that active stylus 400 is closest to, thereby establishing the X position of active stylus 400. And as with the Y determination, the conditions at a clustered grouping of columns may be used to establish a higher positional resolution.

It will also be appreciated that signals received in the stylus-drive subframe can be used to disambiguate Y-position of active stylus 400 in a system with two or more touch-sensing matrices. During the stylus-drive subframe, active stylus 400 will only light up columns on the matrix it was near, thereby enabling the ambiguity to be resolved.

Furthermore, during the stylus-drive subframe, active stylus 400 may transmit stylus information to display device 100 via the electrostatic channel formed between an electrode (e.g., tip 402, eraser 404) of active stylus 400 and touch-sensor matrix 300. As discussed above, various operations may be performed to reduce a size of a report that includes such stylus information in order to transmit the report in an efficient and robust manner such that data transmission via the electrostatic communication channel may be reduced.

To potentially increase the efficiency, speed and accuracy of detecting touch events, the present description contemplates a novel method for simultaneously driving row electrodes 302 during sequentially-occurring touch-sensing frames. Row electrodes 302 are driven by drive circuitry 310 simultaneously in groupings of two or more row electrodes 302, with each grouping being driven over the course of an interval within the touch-sensing frame. In other words, during a touch-sensing frame, each grouping is driven in an associated interval. During that interval, the other row electrodes typically are silent (not driven).

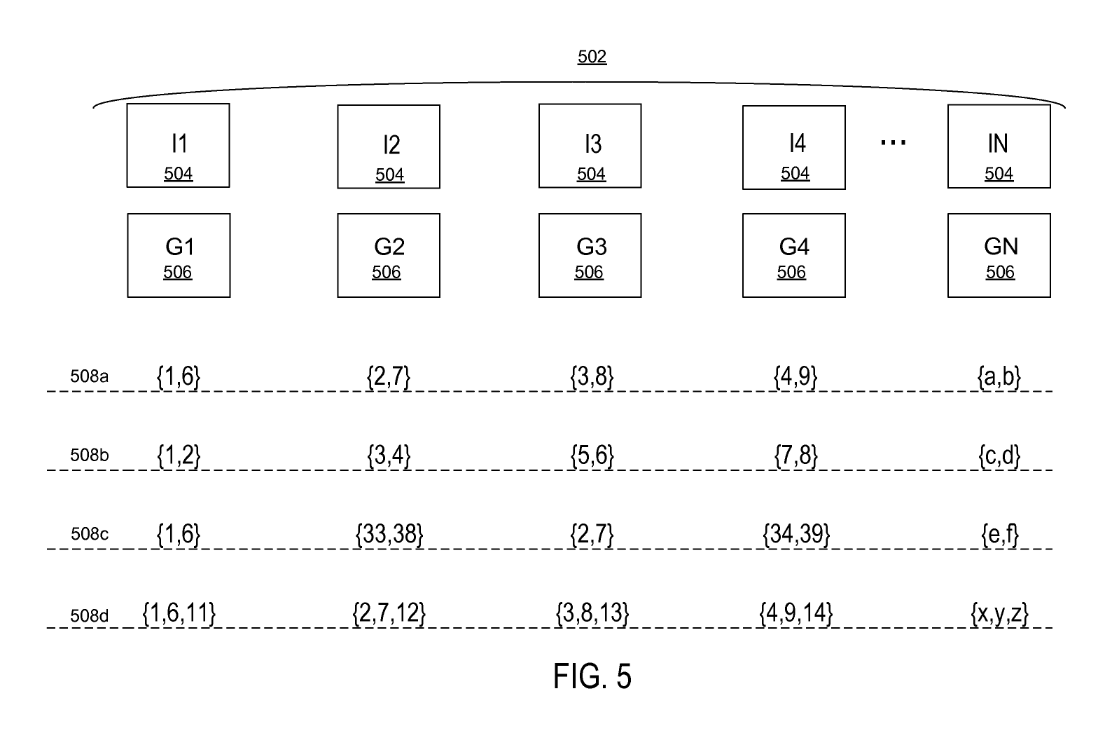

Such an arrangement is depicted in FIG. 5. An individual touch-sensing frame 502 is shown, composed of successively occurring intervals 504 (I1 through IN). It will be appreciated that other time components of touch-sensing frame 502 are not shown (e.g., sync periods; periods during which stylus 400 transmits other data to the touch sensor/matrix; etc.).

In each interval 504, a grouping 506 of row electrodes 302 is depicted (G1 through GN). Accordingly, during interval I1, grouping G1 is driven; during interval 12, grouping G2 is driven, and so on. This progressive driving of the row electrodes 302 influences electrical conditions on the column electrodes 304, which may be interpreted by receive circuitry 314 to detect touch events occurring on matrix 300 during the touch-sensing frame 502.

During each interval 504, the row electrodes in the grouping 506 of that interval are driven simultaneously, and in a plurality of differently-driven drive states, only one of which is used at a time during the interval 504, as explained in more detail below. Typically, each interval is of the same duration, though unequal durations may be employed.

Groupings 506 may take various configurations and may be driven in various sequences. Grouping schemes 508a through 508d of FIG. 5 depict various examples. The conventions of the diagram are as follows. The figure assumes a touch-sensing matrix with J row electrodes 302, numbered 1 through J and, as indicated above, N groupings 506 of row electrodes 302, the groupings being driven one at a time over the N depicted intervals 504. Below each grouping/interval is a grouping of row electrodes 302 with the specific row electrodes in the grouping identified by numbers within braces. For example, in scheme 508a, rows 1 and 6 are driven within the 1st interval I1, rows 2 and 7 are driven within the second interval 12, and so on.

As can be seen from schemes 508a, 508c and 508d, in some examples the groupings 506 omit intervening row electrodes 302. In other words, the row electrodes of the grouping are spaced apart such that they are separated by row electrodes of matrix 300 that are not part of the grouping. In other examples (e.g., scheme 506b), adjacent row electrodes are used without any separation/spacing.

In some cases, spatially proximate groupings are activated close in time, for example during time-adjacent intervals. Such examples are shown in schemes 508a, 508b, and 508d. In each of these examples, in any given interval 504, one of the activated row electrodes of the grouping is directly adjacent to an activated row electrode for the grouping in an immediately adjacent interval 504. Spatially-proximate schemes can also encompass distances of a few rows between activated row electrodes for adjacent intervals. In other examples, e.g., scheme 508c of FIG. 5, wide electrode separation may be employed for the groupings activated during adjacent intervals 504. In many of the examples herein, groupings of two row electrodes 302 will be discussed, though it will be appreciated that three or more row electrodes 302 may be employed within a grouping (see, e.g., scheme 508d of FIG. 5). Still further, it is possible to employ groupings with differing number of row electrodes from grouping to grouping.

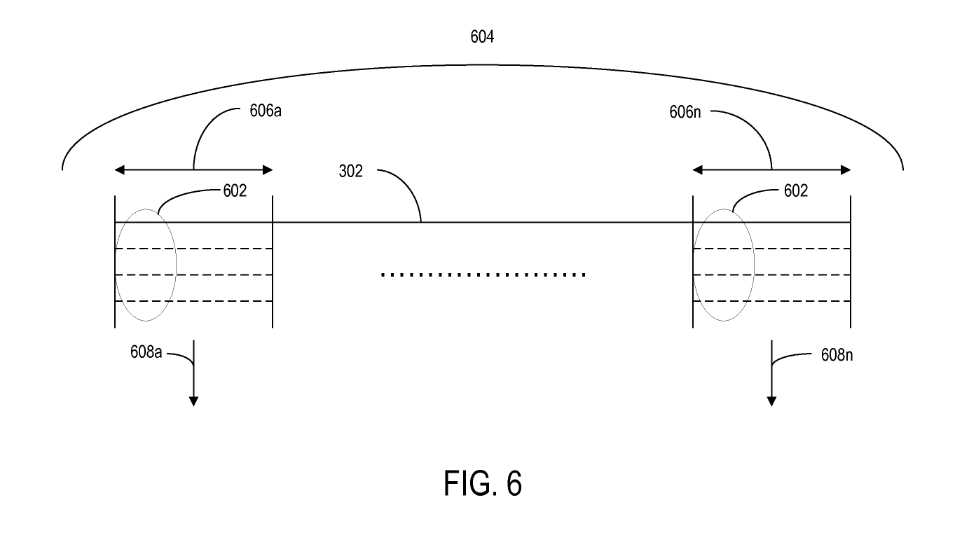

For any given grouping 506 in any given interval 504, drive circuitry 310 is configured to drive the row electrodes 302 of that grouping simultaneously in the interval in multiple differently-driven drive states. Each of the drive states produces its own drive state output for receipt and processing by receive circuitry 314. FIG. 6 depicts such an arrangement. Specifically, the figure shows a grouping 602 of two or more row electrodes 302. The row electrodes 302 are simultaneously driven over interval 604, meaning that for at least part of the interval, drive signals are being applied to multiple row electrodes in the grouping 602 at the same time. Typically, the row electrodes are driven over the entire interval 604, in order to optimize the ability to use the resulting output. As indicated above, the driving of the row electrodes influences electrical conditions occurring on the column electrodes 304, which in turn enables receive circuitry 314 to detect touch events.

In the present example, the row electrodes of the grouping of FIG. 6 are driven in multiple different drive states 606a through 606n. In some cases, it will be desirable to use two different drive states, though three or more may be employed depending on the setting and performance requirements. Each drive state produces its own drive state output 608a through 608n.

In terms of a drive state “producing” an output, it will appreciated that such output may refer to the output signal received into the column receivers 312 of receive circuitry 314, as a result of the interaction between the drive signals, touch events and other factors affecting electrical conditions on the column electrodes. The noise environment is known generally, as is the column electrode effect of each of the possible touch events. A correlation-based receiver may then use a reference signal to gain information about which of the potential touch events occurred. As described below, a drive output in some cases may conclusively determine one or more of the possible touch events, but be inconclusive with respect to one or more other events (i.e., it may not be able to determine whether certain touch events occurred). Further, while many of the examples herein will refer to correlation-based touch detection, it will be appreciated that any other method of detection may be employed within receive circuitry 314.

As described below, in the face of a given one of the possible touch events, one drive state 606 may produce a different drive state output 608 than a another drive state 606. Specifically, for the set of possible touch events associated with the row electrodes in a grouping, the drive states produce differing drive state outputs.

Differing drive state outputs for similar touch events may result from a desirable specialization of drive states. Specifically, it will in some cases be desirable to design one or more of drive states 606 so that they are focused on a specific subset of possible touch events that can occur with respect to the row electrodes 302 of the grouping 602. In some cases, this approach yields drives states which are each configured to detect a different subset of the possible touch events.

For example, in a two-row grouping, there are four possible touch events: (1) no touches; (2) touch only on the first row; (3) touch only on the second row; and (4) touches on each rows. In a scheme with two drive states, one may be specialized to focus on two of these events, with the other drive state focusing on the other two. The specialization would be achieved via use of particularized drive signals in each drive state on the row electrodes.

Drive state specialization may allow for faster detection of the focused-on events, and use of simpler, fewer and less expensive components. Specialized drive states can reduce errors in detecting touch events; provide a more consistent output frequency response; and provide a higher signal-to-noise ratio (SNR) in outputs; among other benefits. In some cases, a given drive state can conclusively identify some of the possible touch events, while being unable to detect other events. For example a particular output level in a drive state may yield ambiguity as between two particular touch events.

In any case, the typical situation is that the differing drive state outputs are collectively, but not individually usable to detect each of the possible different touch events. Referring again to the above example, both drive state outputs would be needed to conclusively determine which of the four events had occurred. In some other examples, one drive state is able to generate a certain “confidence level” or “suspicion” that a particular touch event has occurred, with one or more other drive states assisting in determining that the event of interest has in fact occurred. In other examples, a drive state output may conclusively determine that a touch event has occurred without reference to other drive state outputs.

As indicated above, the drive states 606 within interval 604 for grouping 602 are “differently-driven.” This means that at least one row electrode in the grouping is driven with a drive signal in one drive state 606 that differs from the drive signal used on that row electrode in another drive state 606. The drive signals can differ in any respect: shape, frequency, phase, amplitude, degree of quantization, sign, polarity, etc.

Though nearly any difference in drive signal may be employed, in some of the examples herein, a row electrode is driven in a first drive state with a first drive signal, and then in a second drive state with a second drive signal, where the first and second drive signals are different from one another, including in some cases, the signals being out-of-phase with respect to one another.

In some examples, each electrode grouping includes two electrodes, and two drive states are used in the driving interval. In such an example, the following two drive states may be used: (1) in the first drive state, both row electrodes are driven with the same drive signal; and (2) in the second drive state, the row electrodes are driven with drive signals that are phase-aligned and inverted with respect to one another. Further, the second drive state signals typically are different, and in some cases out-of-phase, with respect to the signal used on the electrodes in the first drive state.

These are but non-limiting examples, a nearly limitless array of drive signals may be used to generate two or more differently-driven drive states in a grouping of two or more row electrodes. In some cases, as in the above-cited example, it may be desirable in implementations with two-electrode groupings to employ a drive state having phase-aligned inverted signals. Such a configuration can enable simplified use of correlation-based detection, by allowing use of a single reference signal in the correlation for that drive state.

The goal of each drive state is to generate information about the set of possible touch events associated with the row electrodes in the grouping. This may include, for each row electrode in the grouping, determining whether or not a touch (e.g., pen or stylus) has occurred at that electrode. The examples herein will typically refer to whether a touch has occurred “at” a particular row electrode, though it will be appreciated that the discussion encompasses interpolation, where relative signal strength occurring at localized groupings of electrodes (rows and/or columns) may be used to interpolate finer position between rows and columns. For example, signal strength distribution about a row receiving a strongest signal can be used to assess granular positional distance to either side of that row.

The number of possible touch events to be detected by the drive states may vary with the number of row electrodes in the grouping. Assuming a four-electrode grouping, the set of possible touch events would be as follows: (1) a touch at none of the electrodes; (2) a touch at all of the electrodes; (3) specific row identities of one-touch, two-touch and three-touch events. In a less complex scenario, and one that is of emphasis herein, the groupings may include two electrodes, referred to in various examples herein as row electrode k and row electrode m. In this example, the set of possible touch events is: (1) a touch at neither row; (2) a touch at only row k; (3) a touch at only row m; (4) touches at both rows k and m. These are but two examples—for a given grouping arrangement, a varying range of touch events might be relevant. In any case, the goal of the differently-driven drive states is to fully resolve all of the possible touch events, that is, to identify specifically which of them occurred during the interval in which the drive states were deployed.

In some examples, as discussed above, it may be desirable to design drive states so that they are specialized toward detecting specific touch events associated with the grouped row electrodes. In some cases, drive state design choices may be made in recognition of differences between touch events. Some touch events may influence column electrode conditions differently than others. Some may be more or less vulnerable to certain types of noise. Some may produce signals having higher or lower SNR. Frequency response of generated signals may vary from one touch event to another. Some touch events may be more or less prone to detection error. These are but a few non-limiting examples. As discussed above, drive state specialization often involves collective use of all of the drive state outputs to fully resolve the set of touch events.

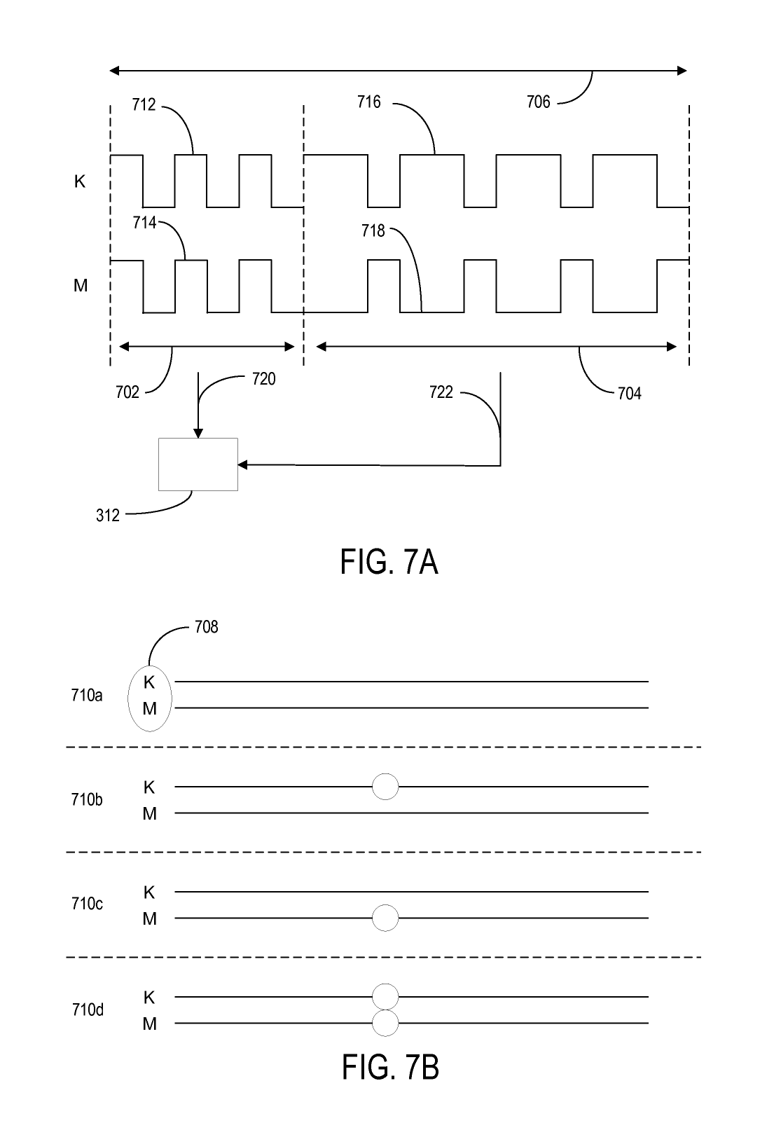

Referring now to FIGS. 7A and 7B, the figures depict a two-row grouping receiving differing drive signals in two differently-driven drive states across a driving interval. FIG. 7A depicts drive states 702 and 704 applied across interval 706 to a grouping of two row electrodes 302, referred to as row k and row m. FIG. 7B shows the grouping 708 of rows k and m, in each of the four possible touch events: (1) touch event 710a—no touch on either row; (2) touch event 710b—a touch only on row k; (3) touch event 710c—a touch only on row m; and (4) touch event 710d—a touch simultaneously on both row k and row m.

Referring to FIG. 7A, during drive state 702, drive signal 712 is applied to row k and drive signal 714 is applied to row m. During drive state 704, drive signal 716 is applied to row k and drive signal 718 is applied to row m. As a result of these drive signals, the touch events 710a-d, noise, etc., drive state 702 produces drive state output 720 and drive state 704 produces drive state output 722, both of which are received into receiver 312 for processing. The drive state outputs are collectively usable to detect all of the touch events. In other words, the drive states and their outputs are configured in this example to fully resolve the set of possible touch events (710a through 710d) by detecting which of them has occurred, with none of the events being undetectable when the two drive state outputs are taken together.

As indicated above, receive circuitry 314 (FIG. 3) may process the signals received from the various column electrodes 304, which are influenced not only by the drive signals, but also by touch events, noise, etc. Typically, and in the example of FIG. 7A, a receiver 312 is provided for each column electrode to process drive state outputs 720 and 722. In the example of FIGS. 7A and 7B, the receiver may perform a correlation to determine whether those outputs correlate to an expected signal (e.g., a signal that would be expected in the event of touch events 710a through 710d).

Referring first to example drive state 704, drive signals 716 and 718 are phase-aligned and inverted relative to one another. The rising and falling edges of drive signal 716 have a certain effect upon the electrical conditions on the column electrodes. These effects are influenced at localized columns when there is a touch on row k (touch event 710b). For drive signal 716, there therefore is an expected incoming signal that would occur when there is a touch on row k. This expected signal may be used in the correlation. The output correlation value, when considered together with a baseline (i.e., expected signal in the absence of touch), can used to affirmatively detect that a touch has occurred on row k.

The same reference signal may be used in a correlation to detect a touch on row m (touch event 710c). In this case, since the drive signal for row m (718) is phase-aligned and inverted relative to signal 716, the same reference signal may be employed in the correlation. However, it will be appreciated that the reverse polarity of drive signal 718 will produce the opposite effect in the presence of a row m touch at any given time, relative to a row k touch (e.g., a reverse current pattern and/or charge moving in an opposite direction). In particular, whenever there is a rising edge on row k, there is a falling edge on row m, and vice versa.

Accordingly, given the opposing polarity of drive signals 716 and 718, a row m touch using the same correlation reference will produce an output tending (in sign) in the other direction, relative to a correlation with the same reference signal on row k. Accordingly, relative to a baseline, a positive correlation output indicates a single touch on one of the rows, with a negative correlation output indicating a single touch on the other of the rows. It will further be appreciated that simultaneous touches on both rows k and m will cancel each other out in the correlation operation. A similar output may arise in the event of no touch (i.e., no change from a baseline value arising in the absence of touch). In this example, the specialization of drive state 704 (i.e., it is configured to resolve only touch events 710b and 710c), allows for use of a single correlator running a single reference, which can allow for simpler components and reduced expense (e.g., non-linear components); higher noise tolerance; and a similar frequency response for both detected touch events, among other benefits.

Referring now to drive state 702, in the present example both row electrodes (k and m) are driven with the same signal (drive signals 712 and 714 are the same). In the event of touches to both row k and row m, the drive signals reinforce each other. As above, this example may involve a correlation in which a reference signal is compared to the received signal on receivers 312 in the receive circuitry 314 attached to the column electrodes 304. The reference signal is based on (usually equal to) the inbound signal that would be expected in the event of a finger/stylus touch on the driven row at the column electrode of interest, taking into account the drive signal, capacitance changes due to touches, noise, etc.

In this example, a touch on one of the two row electrodes k and m would produce a positive correlation, whereas touches on both rows k and m would also produce a positive correlation, but of much higher strength, given the greater capacitance change produced by the two touches. Drive state 702 is thus configured to detect the touch event in which a touch is applied at both rows k and m (touch event 710d). Drive state 702 may further be configured to detect the condition in which a touch is applied at neither row (e.g., no change from a baseline signal in the relevant column receivers). The intermediate correlation signal level, on the other hand, identifies that a single touch is present, but the drive state may not be configured to determine whether that touch is at row k or row m. However, when taken together, drive states 702 and 704 yield outputs which collectively allow detection of all the possible touch events associated with the row electrodes in the groupings.

It will again be appreciated that drive states, as in the above example, may be specialized in the sense that they are configured to detect only some of the possible touch events. By eliminating the need to detect all touch events, the drive state signals may be configured to provide various advantages. Potential benefits include faster detection, higher SNR, reduced vulnerability to errors, simpler and less expensive components, consistent frequency response on all grouped electrodes, etc.

The drive states of FIG. 7A and their specialization may be simplistically summarized as follows. In drive state 704, a baseline value is indeterminate—it can correspond to touches on both rows (touch event 710d) or to no touches (touch event 710a) and cannot distinguish between those two conditions. A first polarity value yields detection of a touch on row k (touch event 710b); an opposing second polarity value corresponds to touch on row m (touch event 710c). In drive state 702, a positive correlation value of intermediate strength is indeterminate—it can correspond to a single touch on row k (touch event 710b) or row m (touch event 710c) and cannot distinguish between those two conditions. A baseline value corresponds to no touches (touch event 710a); a positive correlation value of high strength corresponds to touches on both rows k and row m (touch event 710d). Accordingly, in this example, the drive state outputs are usable collectively, but not individually, to detect all of the possible touch events associated with row k and row m.

Use of differently-driven row electrode groupings typically is performed in order to reduce the time needed to scan all the row electrodes of the touch-sensing matrix. In one example, this reduction may be considered by comparing a scheme with two-row groupings against a non-grouped scanning scheme (i.e., scanning two rows at a time versus scanning one row at a time). If the single-row scheme takes two units of time to determine the set of all possible touch events for two rows (i.e., touch on neither; touch on one; touch on the other; and touches on both), then it will be desirable to construct the drive states for the grouped arrangement so that those four touch events can be determined in less than two units of time.

Continuing with consideration of a single-row scheme, imagine a drive signal used for the row electrodes that produces a similar SNR to the drive signals used in drive state 704 of the example of FIG. 7A. In such a case, to obtain its output with a similar performance level as that available in the single-row approach, drive state 704 may be of a duration equal to one timeslot (the length of time that a single row is driven in the single-row approach). Thus in one timeslot, the single-row approach detects two events (whether or not there is a touch upon its driven row). The two-row approach, using drive state 704, has also, in one timeslot, detected two events (whether there is a touch on the first row, or a touch on the second row).

Accordingly, if drive state 702 were to occur over a one-slot duration (detecting the other two events associated with rows k and m), there would be no time advantage over the single-row approach, since the single-row approach would resolve its other two events in that second timeslot. In other words, in both implementations, two timeslots would be needed to fully detect which of the four touch events had occurred on the two rows being driven.

However, the duration of drive state 702 may be made much smaller in some examples. The logic of the two drive states may be constructed so that the only task of drive state 702 is to determine whether there are touches at both row k and row m (touch event 710d), or no touches (touch event 710a). When touches occur on both rows (710d), the signal amplitude is much higher than with respect to the other touch events. Accordingly, the relevant touch event has a higher associated SNR. Specifically, drive state 702, for the touch events it is configured to detect, produces a higher SNR, relative to drive state 704 and its associated detected events, if drive states 702 and 704 are of the same duration.

This allows the duration of drive state 702 to be reduced without any performance compromise relative to drive state 704, which runs on the same drive and receive electronics in the present example. Accordingly, in this and other examples, the duration of the drive states within the driven interval may be unequal (as in the example of FIG. 7A). This asymmetric lengthening/shortening may be enabled based on the different touch events and drive signals associated with each drive state. In some settings, asymmetric variation of the time durations may also be enabled where the drive signals in the different drive states are independent with no orthogonality requirement.

In some examples, the magnitude of the signal received in receive circuitry 314 and other factors may allow the duration of drive state 702 to be reduced so that it is one fourth as long as drive state 704. Assuming hardware configurations where drive state 704 runs as long as the time used for scanning a single row in a single-row scheme, the two events for a single row (touch or not) in this example can be determined in 0.625 units of time, relative to 1.0 units of time for the single-row scheme.

The time saved in detecting touch events can provide numerous benefits. Scanning intervals may be increased to improve SNR. For example, more pulses may be used, a lower carrier frequency may be employed to avoid noise sources or to provide other benefits. Added time can support a larger sensor (e.g., with more row electrodes). Other portions of the overall touch-sensing frame (i.e., other than used for progressive row scanning) may be allocated more time. This additional allocation can be used for improved stylus syncing, extra electrostatic data transfer between a stylus and display device, additional styluses, etc.

One alternate way to increase the speed of row scanning operations is to drive two rows simultaneously with orthogonal signals. Theoretically, this may be twice as fast as a single-row approach. i.e., in the above example, resolving the two touch events for a single row would take 0.5 units of time. Typically, however, the receive circuitry is complex and expensive to implement in such a configuration. Compared to single row excitation, the receive circuitry may need to support higher input and dynamic range to maintain resolution. Typically, two receivers must be running on each column (i.e., two correlations running simultaneously with different reference signals). Still further, it may be difficult due to noise and other environmental conditions to design the system so that signals at the output side are in fact orthogonal.

The drive state approach examples described herein may be easier and less expensive to implement than such an orthogonal approach. Typically, the different drive signals used in the drive states do not have an orthogonality requirement, making the system easier to design. In the two-row implementation described above, at any given time, the signals on the two rows have similar frequency responses, which can facilitate avoiding noise and provide other benefits. In the case of differing frequency response, one row could be more vulnerable to noise. In examples with only one receiver per column (i.e., one correlator per column running one correlation reference sequence at a time), the system may be more robust to synchronization/phase error. Being free from an orthogonality requirement may facilitate running drive states in differing sequences and variations.

From the above, it will be appreciated that in many examples, the per-column detectors in receive circuitry 314 may be configured as single correlation-based receivers. In other words, the receiver need only support the ability to run one correlation reference sequence at a time. In this case, the detector may be reconfigured between drive states to cause the detector to be tuned to the drive signals being used in each drive state. In the above example of drive state 702 and drive state 704, each column receiver would be tuned to run correlations based on the outputs expected as a result of the drive signals used in the drive states. One reference signal would be used for drive state 702 and a second, different reference signal would be used for drive state 704. As indicated above, a single reference may be used in drive state 704, since the two drive signals are phase-aligned and inverted relative to one another. During transitions between drive states, the receiver would be reset to use the appropriate reference signal.

In some cases it may be desirable to avoid reconfiguring/resetting the receivers between drive states. In such a case, a separate receiver may be used on each column for each needed reference signal. With reference to the example of FIG. 7A, one receiver would run the reference for drive state 702 while the other receiver would run the reference for drive state 704. In other words, one receiver would be “listening” for the events of the first drive state, and the other would be listening for the events of the other drive state.

Within an interval, drive states may be arranged in any particular order. In the example of FIG. 7A, drive state 702 may come first, followed by drive state 704, or vice versa. Still further, within an interval, there may be multiple occurrences of a given drive state. Drive states may also be interleaved such that multiple occurrences of one drive state are separated by occurrences of one or more other drive states. For example, a given Drive State A and a given Drive State B may be interleaved within an interval as follows: ABAB or ABABAB, etc. Interleaving and various sequences may also be employed with 3 or more drive states. In some cases, interleaving may provide protection against noise, particularly against “burst” noise which occurs at high levels over short durations. For example, if drive state 702 were spread over an interval in two different instances, a short duration noise event might only affect one of the instances. Accordingly, only half or less of that drive state's duration would be affected due to the protection provided by the interleaving.

Typically, and particularly when the system is used with an active stylus, it will be desirable for the row electrodes in each grouping to be spaced apart (e.g., separated by a few inactive electrodes). In some cases, for example, closely-adjacent row signals of opposite polarity may create a cancelling effect on the stylus. This may make it difficult or impossible to determine which row the stylus is close to. On the other hand, if spacing is significantly increased, various issues may arise with duplicated or missed touches.

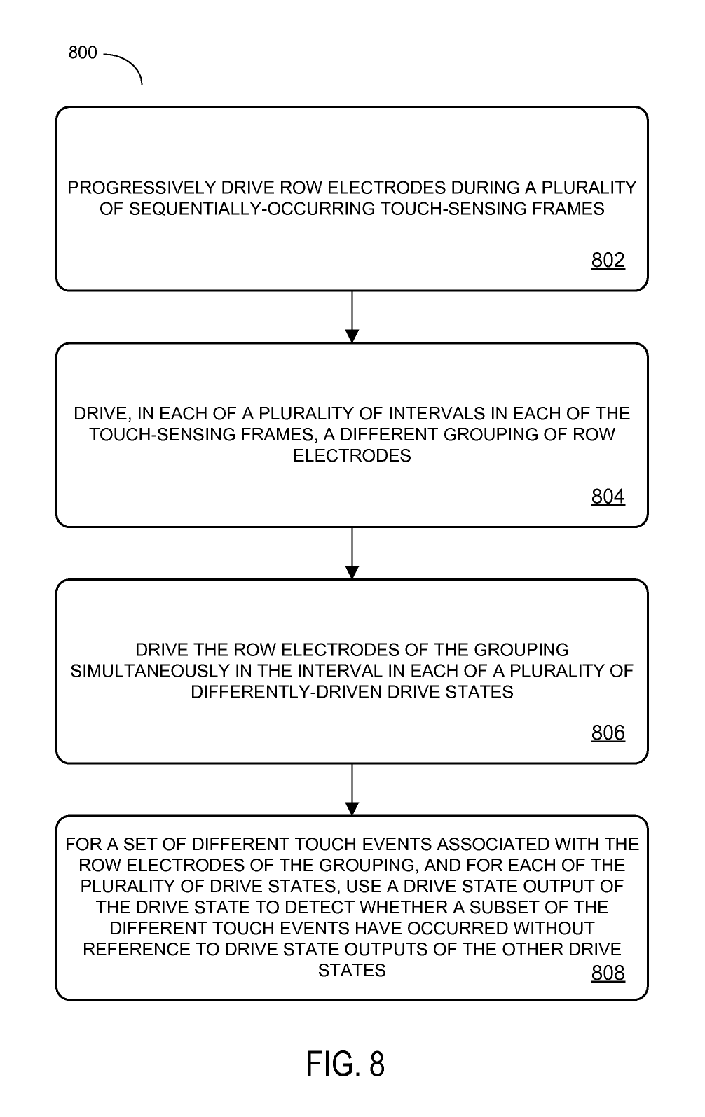

Turning now to FIG. 8, the figure depicts a touch-sensing method 800, in which differently-driven drive states are used in connection with row electrode groupings. The method may be implemented in a variety of different hardware configurations, though the general context is a touch sensor having a matrix of row electrodes and column electrodes.

At 802, method 800 includes progressively driving the row electrodes during a plurality of sequentially-occurring touch-sensing frames. The driving of the row electrodes influences electrical conditions on the column electrodes. These influenced conditions may be further influenced in predictable ways by touch events on the driven rows (e.g., a touch on a driven row at a particular column may cause an expected signal to occur on the column). Receive circuitry attached to the column electrodes may be configured to process received signals in order to detect touch events occurring at row/column intersections on the matrix.

Each of the touch-sensing frames includes a plurality of different intervals. At 804, method 800 includes, for each interval in each touch-sensing frame, driving a different grouping of the row electrodes. The driving typically is performed so that only one grouping is driven per interval. Electrode groupings may include row electrodes in any distribution, spacing, and/or arrangement, and may include any practicable number of electrodes.

At 806, method 800 includes, in each interval, driving the row electrodes of the grouping in each of a plurality of differently-driven drive states. Typically, only one of the drive states is used at a time in the interval. Many of the examples above implement two different drive states, though three or more may be employed within an interval. In some cases, each drive state will be driven for the same amount of time in the interval. In other cases, drive states may be driven for different durations. For example, in some cases, detecting certain touch events may enable configuring drive signals for a drive state to yield a relatively higher SNR, which may enable that drive state to be used for a relatively shorter period of time while still providing adequate touch detection performance. As in the above examples, drive states may be employed in any sequence through an interval. Multiple instances of a drive state may be employed within an interval, in some cases with interleaving, for example to decrease vulnerability to noise.

As discussed above, a variety of drive signal variations may be used to provide differentiated drive states. In general, in a grouping, at least one row electrode is driven with a drive signal in one drive state that differs from the drive signal used on that row electrode in another drive state. In some cases, those two signals can be different from and out of phase with one another. The drive signals can differ in any respect: shape, frequency, phase, amplitude, degree of quantization, sign, polarity, etc.

At 808, method 800 includes, for a set of different touch events associated with the row electrodes of the grouping, and for each of the plurality of drive states, using a drive state output of the drive state to detect whether a subset of the different touch events have occurred without reference to drive state outputs of the other drive states.

In some examples, the drive states include a first drive state and a second drive state. The drive signals for the two different drive states may be differently configured to specifically focus on detecting a subset of the possible touch events. For example, as discussed above, a two-row grouping has four possible touch events at any instant: (1) no touch; (2) a touch on only the first row; (3) a touch on only the second row; and (4) touches on both rows. Drive signals for a first drive state may be configured to detected events (2) and (3), with drive signals for another state configured to detect one or both of events (1) and (4).

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices.

Computing system 900 includes a logic machine 902 and a storage machine 904. Computing system 900 may optionally include a display subsystem 906, input subsystem 908, communication subsystem 910, and/or other components not shown in FIG. 9.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result. For example, hardware/software instructions may be employed to coordinate drive and receive activity of circuitry 310 and 314 (FIG. 3), including selection and application of drive signals; coordinating use of drive states; running correlations to detect touch events; etc.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold instructions executable by the logic machine to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 implemented to perform a particular function. In some cases, a module, program, or engine may be instantiated via logic machine 902 executing instructions held by storage machine 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 906 may be used to present a visual representation of data held by storage machine 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

In one example, a touch-sensitive display device comprises: a touch sensor having a matrix of row electrodes and column electrodes; receive circuitry attached to the column electrodes; drive circuitry configured to progressively drive the row electrodes during sequentially-occurring touch-sensing frames to influence electrical conditions on the column electrodes, the receive circuitry being configured to interpret such electrical conditions to detect touch events occurring on the matrix during the touch-sensing frames; where the drive circuitry is configured to, in each of a plurality of intervals in each of the touch-sensing frames, drive a different grouping of the row electrodes, such that only that grouping is driven during the interval; where the drive circuitry is configured to drive the row electrodes for a given grouping simultaneously in the interval in each of a plurality of differently-driven drive states, only one of which is used at a time during the interval; and where, for a set of possible touch events associated with the row electrodes of the grouping, the drive states produce differing drive state outputs that collectively, but not individually, are usable to detect each of the different touch events. In this example or any other example, each of the groupings includes a first row electrode and a second row electrode; during a first drive state, the first row electrode and the second row electrode are each driven with a first drive signal; and during a second drive state, the first row electrode is driven with a second drive signal that is different than the first drive signal. In this example or any other example, during the second drive state, the second row electrode is driven with a third drive signal that is phase-aligned and inverted with respect to the second drive signal. In this example or any other example, for a row electrode within a grouping, the drive circuitry is configured to (1) drive such row electrode with a first drive signal in a first drive state; and (2) drive such row electrode with a second drive signal in a second drive state, where the first drive signal and the second drive signal are different from one another. In this example or any other example, the receive circuitry includes, for each column electrode, a detector, and the receive circuitry is configured to reconfigure the detector between the first drive state and the second drive state in order to cause the detector to be tuned, respectively, to the first drive signal and the second drive signal. In this example or any other example, the drive circuitry is configured to drive the row electrodes of the grouping so that one of the drive states is driven within the interval for a different duration than another of the drive states. In this example or any other example, a first drive state is configured to detect a first portion of the possible touch events and a second drive state is configured to detect a second portion of the possible touch events, and drive signals for the first drive state are configured, relative to drive signals for the second drive state, to produce a higher signal-to-noise ratio for the first portion of the possible touch events relative to the second portion of the possible touch events. In this example or any other example, a first drive state and a second drive state are interleaved such that one of the first and second drive states occurs more than once during the interval and two of its occurrences are separated by an occurrence of the other of the first and second drive states. In this example or any other example, each of the drive states is configured to detect a different subset of possible touch events. In this example or any other example, each grouping includes a first row electrode and a second row electrode; the set of possible touch events includes (1) Event A—no touch at either of the first row electrode and second row electrode; (2) Event B—a touch at the first row electrode; (3) Event C—a touch at the second row electrode; and (4) Event D—a touch at both the first row electrode and the second row electrode; and a first drive state is configured to detect one or more of Events A-D, and a second drive state is configured to detect the remaining of Events A-D. In this example or any other example, in each grouping, the row electrodes of such grouping are spaced apart such that they are separated by row electrodes of the matrix that are not part of the grouping.

In an example, a touch-sensing method comprises: in a touch sensor having a matrix of row electrodes and column electrodes, progressively driving the row electrodes during a plurality of sequentially-occurring touch-sensing frames to influence electrical conditions on the column electrodes; in each of a plurality of intervals in each of the touch-sensing frames, the progressive driving including driving a different grouping of the row electrodes, such that only that grouping is driven during the interval; in each of the intervals, the driving of the grouping includes driving the row electrodes of the grouping simultaneously in the interval in each of a plurality of differently-driven drive states, only one of which is used at a time during the interval; and for a set of possible touch events associated with the row electrodes of the grouping, and for each of the plurality of drive states, using a drive state output of the drive state to detect whether a subset of the possible touch events have occurred without reference to drive state outputs of the other drive states. In this example or any other example, the drive states include a first drive state and a second drive state, and drive signals for the first drive state and drive signals for the second state are differently configured to cause detection of different touch events via receive circuitry attached to the column electrodes. In this example or any other example, driving the row electrodes of the grouping includes driving one of the drive states in the interval for a different duration than another of the drive states. In this example or any other example, for a row electrode within a grouping, the row electrode is driven with a first drive signal in a first drive state, and with a second drive signal in a second drive state, where the first drive signal and the second drive signal are different from one another. In this example or any other example, each grouping includes a first row electrode and a second row electrode, and driving the row electrodes of the grouping includes: (1) during a first drive state, driving each of the first row electrode and the second electrode with a first drive signal; (2) during a second drive state, driving the first row electrode with a second drive signal that is different than the first drive signal; and (3) during the second drive state, driving the second row electrode with a third drive signal that is phase-aligned and inverted with respect to the second drive signal.

In an example, a touch-sensitive display device comprises: a touch sensor having a matrix of row electrodes and column electrodes; receive circuitry attached to the column electrodes; drive circuitry configured to progressively drive the row electrodes during sequentially-occurring touch-sensing frames to influence electrical conditions on the column electrodes, the receive circuitry being configured to interpret such electrical conditions to detect touch events occurring on the matrix during the touch-sensing frames; where the drive circuitry is configured to, in each of a plurality of intervals in each of the touch-sensing frames, drive a different grouping of the row electrodes, such that only that grouping is driven during the interval; where the drive circuitry is configured to drive the row electrodes for a given grouping simultaneously in the interval in each of a plurality of differently-driven drive states, only one of which is used at a time during the interval; where within each of the groupings, the drive circuitry is configured to (1) drive a row electrode with a first drive signal in a first drive state; and (2) drive that row electrode with a second drive signal in a second drive state, where the first drive signal and the second drive signal are different from one another; and where for a set of possible touch events associated with the row electrodes of the grouping, the first drive state and the second drive state produce differing drive state outputs that collectively, but not individually, are usable to detect each of the possible touch events. In this example or any other example, the receive circuitry includes, for each column electrode, a detector, and the receive circuitry is configured to reconfigure the detector between the first drive state and the second drive state in order to cause the detector to be tuned, respectively, to the first drive signal and the second drive signal. In this example or any other example, the drive circuitry is configured to drive the row electrodes of each grouping so that the first drive state is driven within the interval for a different duration than the second drive state. In this example or any other example, the first drive state is configured to detect a first portion of the possible touch events and the second drive state is configured to detect a second portion of the possible touch events, and drive signals for the first drive state are configured, relative to drive signals for the second drive state, to produce a higher signal-to-noise ratio for the first portion of the possible touch events relative to the second portion of the possible touch events.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A touch-sensitive display device, comprising:
a touch sensor having a matrix of row electrodes and column electrodes;
receive circuitry attached to the column electrodes;
drive circuitry configured to progressively drive the row electrodes during sequentially-occurring touch-sensing frames to influence electrical conditions on the column electrodes, the receive circuitry being configured to interpret such electrical conditions to detect touch events occurring on the matrix during the touch-sensing frames;
where the drive circuitry is configured to, in each of a plurality of intervals in each of the touch-sensing frames, drive a different grouping of the row electrodes, such that only that grouping is driven during the interval;
where the drive circuitry is configured to drive the row electrodes for a given grouping simultaneously in the interval in each of a plurality of differently-driven drive states, only one of which is used at a time during the interval; and
where, for a set of possible touch events associated with the row electrodes of the grouping, the drive states produce differing drive state outputs that collectively, but not individually, are usable to detect each of the different touch events.

2. The touch-sensitive display device of claim 1, where
each of the groupings includes a first row electrode and a second row electrode;
during a first drive state, the first row electrode and the second row electrode are each driven with a first drive signal; and
during a second drive state, the first row electrode is driven with a second drive signal that is different than the first drive signal.

3. The touch-sensitive display device of claim 2, where during the second drive state, the second row electrode is driven with a third drive signal that is phase-aligned and inverted with respect to the second drive signal.

4. The touch-sensitive display device of claim 1, where for a row electrode within a grouping, the drive circuitry is configured to (1) drive such row electrode with a first drive signal in a first drive state; and (2) drive such row electrode with a second drive signal in a second drive state, where the first drive signal and the second drive signal are different from one another.

5. The touch-sensitive display device of claim 4, where the receive circuitry includes, for each column electrode, a detector, and where the receive circuitry is configured to reconfigure the detector between the first drive state and the second drive state in order to cause the detector to be tuned, respectively, to the first drive signal and the second drive signal.

6. The touch-sensitive display device of claim 1, where the drive circuitry is configured to drive the row electrodes of the grouping so that one of the drive states is driven within the interval for a different duration than another of the drive states.

7. The touch-sensitive display device of claim 1, where a first drive state is configured to detect a first portion of the possible touch events and a second drive state is configured to detect a second portion of the possible touch events, and where drive signals for the first drive state are configured, relative to drive signals for the second drive state, to produce a higher signal-to-noise ratio for the first portion of the possible touch events relative to the second portion of the possible touch events.

8. The touch-sensitive display device of claim 1, where a first drive state and a second drive state are interleaved such that one of the first and second drive states occurs more than once during the interval and two of its occurrences are separated by an occurrence of the other of the first and second drive states.

9. The touch touch-sensitive display device of claim 1, where each of the drive states is configured to detect a different subset of possible touch events.

10. The touch touch-sensitive display device of claim 9,
where each grouping includes a first row electrode and a second row electrode;
where the set of possible touch events includes (1) Event A—no touch at either of the first row electrode and second row electrode; (2) Event B—a touch at the first row electrode; (3) Event C—a touch at the second row electrode; and (4) Event D—a touch at both the first row electrode and the second row electrode; and
where a first drive state is configured to detect one or more of Events A-D, and a second drive state is configured to detect the remaining of Events A-D.

11. The touch-sensitive display device of claim 1, where in each grouping, the row electrodes of such grouping are spaced apart such that they are separated by row electrodes of the matrix that are not part of the grouping.

12. A touch-sensing method, comprising:
in a touch sensor having a matrix of row electrodes and column electrodes, progressively driving the row electrodes during a plurality of sequentially-occurring touch-sensing frames to influence electrical conditions on the column electrodes;
in each of a plurality of intervals in each of the touch-sensing frames, the progressive driving including driving a different grouping of the row electrodes, such that only that grouping is driven during the interval;
in each of the intervals, the driving of the grouping includes driving the row electrodes of the grouping simultaneously in the interval in each of a plurality of differently-driven drive states, only one of which is used at a time during the interval; and
for a set of possible touch events associated with the row electrodes of the grouping, and for each of the plurality of drive states, using a drive state output of the drive state to detect whether a subset of the possible touch events have occurred without reference to drive state outputs of the other drive states.

13. The method of claim 12, where the drive states include a first drive state and a second drive state, and where drive signals for the first drive state and drive signals for the second state are differently configured to cause detection of different touch events via receive circuitry attached to the column electrodes.

14. The method of claim 12, where driving the row electrodes of the grouping includes driving one of the drive states in the interval for a different duration than another of the drive states.

15. The method of claim 12, where for a row electrode within a grouping, the row electrode is driven with a first drive signal in a first drive state, and with a second drive signal in a second drive state, where the first drive signal and the second drive signal are different from one another.

16. The method of claim 12, where each grouping includes a first row electrode and a second row electrode, and where driving the row electrodes of the grouping includes:
(1) during a first drive state, driving each of the first row electrode and the second electrode with a first drive signal;
(2) during a second drive state, driving the first row electrode with a second drive signal that is different than the first drive signal; and
(3) during the second drive state, driving the second row electrode with a third drive signal that is phase-aligned and inverted with respect to the second drive signal.

17. A touch-sensitive display device, comprising:
a touch sensor having a matrix of row electrodes and column electrodes;
receive circuitry attached to the column electrodes;
drive circuitry configured to progressively drive the row electrodes during sequentially-occurring touch-sensing frames to influence electrical conditions on the column electrodes, the receive circuitry being configured to interpret such electrical conditions to detect touch events occurring on the matrix during the touch-sensing frames;
where the drive circuitry is configured to, in each of a plurality of intervals in each of the touch-sensing frames, drive a different grouping of the row electrodes, such that only that grouping is driven during the interval;
where the drive circuitry is configured to drive the row electrodes for a given grouping simultaneously in the interval in each of a plurality of differently-driven drive states, only one of which is used at a time during the interval;
where within each of the groupings, the drive circuitry is configured to (1) drive a row electrode with a first drive signal in a first drive state; and (2) drive that row electrode with a second drive signal in a second drive state, where the first drive signal and the second drive signal are different from one another; and
where, for a set of possible touch events associated with the row electrodes of the grouping, the first drive state and the second drive state produce differing drive state outputs that collectively, but not individually, are usable to detect each of the possible touch events.

18. The touch-sensitive display device of claim 17, where the receive circuitry includes, for each column electrode, a detector, and where the receive circuitry is configured to reconfigure the detector between the first drive state and the second drive state in order to cause the detector to be tuned, respectively, to the first drive signal and the second drive signal.

19. The touch-sensitive display device of claim 17, where the drive circuitry is configured to drive the row electrodes of each grouping so that the first drive state is driven within the interval for a different duration than the second drive state.

20. The touch-sensitive display device of claim 17, where the first drive state is configured to detect a first portion of the possible touch events and the second drive state is configured to detect a second portion of the possible touch events, and where drive signals for the first drive state are configured, relative to drive signals for the second drive state, to produce a higher signal-to-noise ratio for the first portion of the possible touch events relative to the second portion of the possible touch events.
